(19) United States
(12) Patent Application Publication
(10) Pub. No.: US 2003/0038497 A1
(43) Pub. Date: Feb. 27, 2003

(54) Automobile tailgate guard

(76) Inventor: Paul J. Fitzgerald, Fayston, VT (US)

Correspondence Address: Law Offices Eric R. Benson, Esq., Eric R. Benson, Champlain Station, Box 65238, Burlington, VT, 05406-5238, US

(21) Appl. No.: 10/213,718

(22) Filed: Aug. 6, 2002

Related U.S. Application Data
(60) Provisional application No. 60/310,431, filed on Aug. 6, 2001.

(51) Int. Cl. B60R 13/01

(52) U.S. Cl. 296/39.1

(57) ABSTRACT

A new, novel and useful automobile tailgate guard comprising a folding or recoiling mat, removably installed in: the trunk area of an automobile with a relatively flat trunk cargo area; or the cargo area of a vehicle with a hatchback or swinging door access, such as a SUV, station wagon, van, or mini van. When folded in place, the automobile tailgate guard lies flat down against floor at the threshold of the of the cargo area. When unfolded, one panel of the automobile tailgate guard remains fastened in place inside the threshold of the cargo area, while the other panels extend out through the open hatchway (hatchback door raised or swing away doors open) to provide at least one flap of material which covers the threshold, bumper and rear end area of the vehicle. When extended the automobile tailgate guard provides a clean place to sit at the tailgate of the vehicle, preventing road grime from the rear bumper and vehicle panels from getting on clothing. When extended the automobile tailgate guard provides a shield for a person leaning into the cargo area of the vehicle to prevent clothing from becoming soiled against the bumper and rear panel of the vehicle.

### BACKGROUND OF THE INVENTION

### FIELD OF THE INVENTION

The present invention relates to a new, novel and useful automobile tailgate guard. This invention relates to a removably attached folding or recoiling mat that is easily folded or recoiled and stored in the rear of an automobile of many types, such that the mat may be opened and laid open upon the rear bumper and fender areas of the automobile to facilitate sitting or leaning upon the automobile on the clean mat surface.

A diligent search of the relevant art and trade journals indicates that there appears to be no prior art suggesting the current invention. Despite the long felt need for such a device there appears to be no commercially available device available that accomplishes the functions of the present invention.

The present invention is capable of being practiced in a variety of sizes and storage configurations suitable for the needs of the vendor. The design regardless of the size and numbers of folds or roller recoiled design will still fit in a variety of motor vehicles with an ease of extension and use, as well as storage after use.

The present invention has several applications and benefits. Skiers, for example, may can sit cleanly and comfortably on the automobile tailgate guard while changing into and out of their ski boots and/or clothes without fear of soiling expensive ski clothes on the bumper and tail panels of the auto. Golfers can sit cleanly comfortably and change into and out of their golf shoes. Equestrian riders can sit cleanly and comfortably while changing boots and gear. Shoppers can lean into the rear of the vehicle on to the automobile tailgate guard to deposit groceries, bags and boxes without soiling clothes on the automobile bumper and panels. Tailgate party goers can sit cleanly and comfortably on the automobile tailgate guard while enjoying any event.

There has thus been outlined, rather broadly, the more important features of the invention in order that the detailed description thereof that follows may be better understood, and in order that the present contribution to the art may be better appreciated. There are additional features of the invention that will be described hereinafter and which will form the subject matter of the claims that follow herein.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting in any way the scope of this invention or claims which follow herein.

As such, those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions and methods insofar as they do not depart from the spirit and scope of the present invention.

Further, the purpose of the foregoing abstract is to enable the U.S. Patent and Trademark Office and the public generally, and especially the scientists, engineers, and practitioners in the art who are not familiar with patent or legal terms or phraseology, to determine quickly from a cursory inspection, the nature and essence of the technical disclosure of the application. The abstract is neither intended to define the invention of the application, which is measured by the claims, nor is it intended to be limiting as to the scope of the invention in any way.

It is therefore an object of the present invention to provide an automobile tailgate guard apparatus which has many advantages mentioned heretofore and many novel features that result in an automobile tailgate guard which is not anticipated, rendered obvious, suggested, or even implied by any prior art automobile tailgate guards, either alone or in any combination thereof.

It is another object of the present invention to provide a new and novel automobile tailgate guard which may be easily and efficiently manufactured, taught and marketed.

It is a further object of the present invention to provide a new and novel automobile tailgate guard which is of a durable and reliable construction and method.

An even further object of the present invention is to provide a new and novel automobile tailgate guard which is susceptible of a low cost of manufacture with regard to both materials and labor, and which accordingly is then susceptible of low prices of sale to the consuming public, thereby making such automobile tailgate guard economically available to the buying public.

Still yet another object of the present invention is to provide a new and novel automobile tailgate guard which provides in the apparatuses and methods of the prior art some of the advantages thereof, while simultaneously overcoming some of the disadvantages normally associated therewith.

These together with other objects of the invention, along with the various features of novelty which characterize the invention, will be pointed out with particularity in the claims which follow herein. For a better understanding of the invention, its operating advantages and the specific objects attained by its uses, reference should be had to the accompanying drawings and descriptive matter in which there is illustrated preferred embodiments of the invention.

### BRIEF DESCRIPTION OF THE DRAWINGS

The invention will be better understood and objects other that those set forth above will become apparent when consideration is given to the following detailed description thereof Such description makes reference to the annexed drawings wherein:

FIG. 1 is a perspective view of the hook and loop attachment means automobile tailgate guard in an open condition;

FIG. 2 is a perspective view of the hook and loop attachment means automobile tailgate guard in a folded condition;

FIG. 3 is a perspective view of the D-Ring attachment means automobile tailgate guard in an open condition;

FIG. 4 is a perspective view of the D-Ring attachment means automobile tailgate guard in a folded condition;

FIG. 5 is a perspective view of the recoiling means automobile tailgate guard in an open condition;

FIG. 6 is a perspective view of the recoiling means automobile tailgate guard in an recoiled condition;

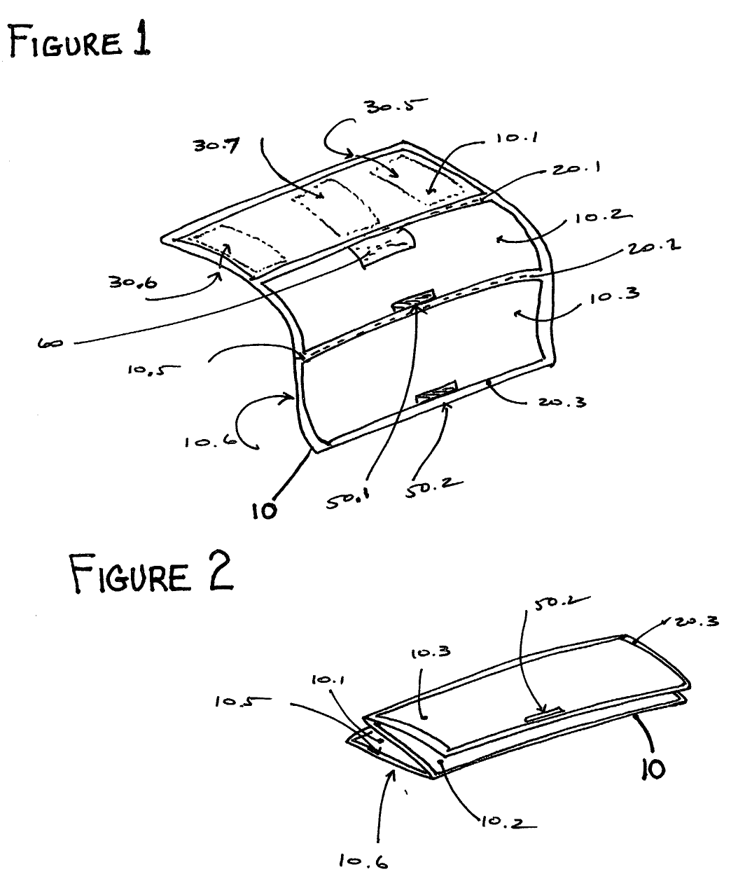

In the preferred embodiment as depicted in FIGS. 1-4, and the present invention is generally designated by the numeral 10, and is comprised of three panels 10.1, 10.2, and 10.3. In FIGS. 1-4 the panels 10.1, 10.2, 10.3 are of similar size and constructed of fabric laminated neoprene foam rubber, however, the panels 10.1, 10.2, 10.3 may be of different sizes and made of any suitable material to suit the requirements of the vendor.

In another embodiment (not shown), panel 10.1 may be cut to a shape and size to fit the cargo area of the vehicle, acting as a partial or total, cargo area protective cover. Panels 10.2 & 10.3 would then be cut to the width of the opening threshold and fold upon one another.

In FIG. 1-4 the panels 10.1, 10.2, and 10.3 are attached via an attachment means which consists of sewn, hook and loop (Velcro®), loop and rod, and/or glued fabric hinges 20.1 and 20.2.

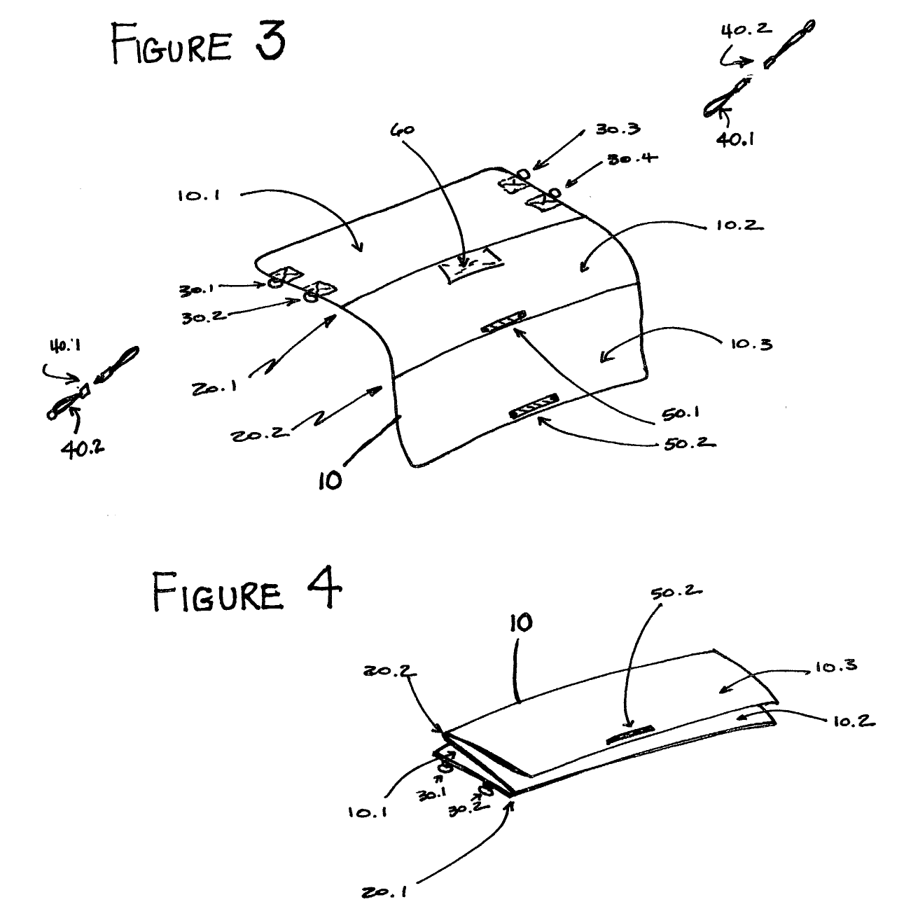

In the embodiment depicted in FIGS. 3-4, the device 10 is removably attached into the desired vehicle area by removably attaching the sewn in D-Rings 30.1, 30.2, 30.3, and 30.4 on the underside of the panel 10.1 of the device to the corresponding clip & strap assemblies which are comprised of a male component 40.1 and a female component 40.2. The female component 40.2 removably attaches to the vehicles cargo hold down lug. The male component 40.1 removably attaches to the sewn in D-Rings 30.1, 30.2, 30.3, and 30.4 on the underside of the panel 10.1 of the device 10 to provide for the best fit of device 10 to the tailgate threshold of the vehicle.

As depicted in FIGS. 1-4 the device 10 is folded and unfolded using strap handles 50.1 and 50.2 which are generally sewn in place. The handle 50.1 is attached to panel 10.2 adjacent to seam/hinge 20.2. The second handle 50.2 is attached to panel 10.3 adjacent to the bottom edge of the panel 20.3.

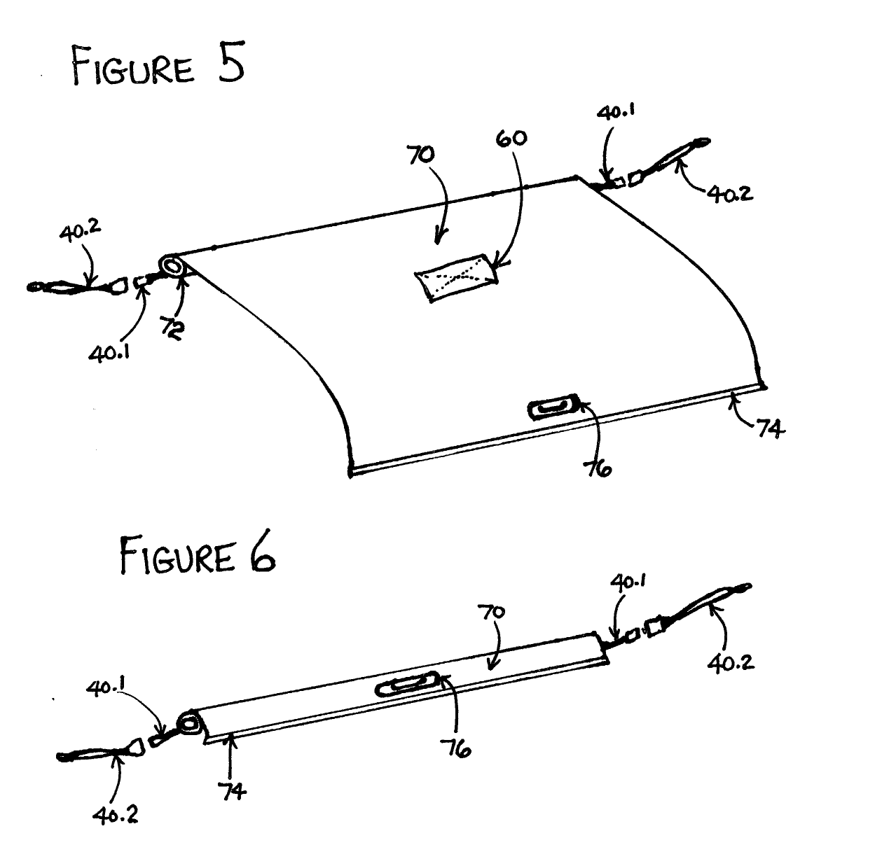

As depicted in FIGS. 1, 3 & 5 the device 10 in FIGS. 1 & 3 and the embodiment of the device 70 in FIG. 5 has a sewn in reinforcement patch 60, sewn onto the underside of the device 10 or 70 and the reinforcement patch 60 is located on the centerline of the device 10 or 70 to provide extra protection from the tailgate or trunk latch assembly of the motor vehicle.

FIG. 1 & 2 depict the device 10 consisting of three panels 10.1, 10.2, and 10.3 sandwiched between a top layer 10.5 and a bottom layer 10.6 of synthetic fabric material. The panels 10.1, 10.2, and 10.3 are formed when the top layer 10.5 is bonded to the bottom layer 10.6. In one embodiment, the top layer 10.5 is bonded to bottom layer 10.6 by stitching the two layers together all around the edge 20.3 and around the panels 10.1, 10.2, and 10.3, creating the Z-shaped folding device 10 with sewn hinges 20.1 and 20.2.

In another embodiment as depicted in FIGS. 1 & 2, top layer 10.5 is bonded to bottom layer 10.6 by gluing the two layers together all around the edge 20.3 and around the panels 10.1, 10.2, and 10.3, creating the Z-shaped folding device 10 with sewn hinges 20.1 and 20.2.

In yet another embodiment as depicted in FIGS. 1 & 2, top layer 10.5 is bonded to bottom layer 10.6 by heat or high frequency sealing the two layers together all around the edges 20.3 and around the panels 10.1, 10.2, and 10.3, creating the Z-shaped folding device 10 with sewn hinges 20.1 and 20.2.

In still another embodiment as depicted in FIGS. 1 & 2, the device is removably attached into the vehicle cargo area at three attachment points on the vehicle. The underside of the panel 10.1 of the device 10 is equipped with three attached strips 30.5, 30.6, and 30.7 of suitable material such as adhesive backed hook and loop (Velcro®) which will then removably attached to the corresponding attachment points on the vehicle.

FIGS. 5-6 depict the device 70 wherein the device 70 is made of suitable material and is stored in a recoiled position as depicted in FIG. 6 by the roller means 72 when not in use. A user simply grabs the handle 76 and draws out the desired length of the material of the device 70 locking it into the desired length with the roller means 72. Adjacent to the handle 76 is a stiffening means 74 made of suitable material to maintain a rigidity of the end of the device 70 such that a user is only required to use one hand while drawing out the desired length of the device 70 allowing the user to easily drape the device 70 over the back of the vehicle within which it is being used. The device 70 is removably attached into the desired vehicle area by removably attaching the removably attached male component 40.1 of the device 70 to the female component 40.2. The female component 40.2 being removably attached to the vehicle's cargo hold down lug. The male component 40.1 removably attaches to the roller means 72 of the device 70 to provide for the best fit of device 70 to the tailgate threshold of the vehicle.

Those who are skilled in the art will readily perceive various modifications which fall within the spirit and scope of the invention. Therefore, the claims which follow herein are to be construed to cover all equivalent structures.

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modification and changes will readily occur to those skilled in the art, it is not desired to limit the invention the exact construction and operation shown and described, and accordingly, all suitable modifications and equivalents may be resorted to, falling within the scope of the invention.

Having described our invention, I claim:

1. An automobile tailgate guard comprising:
a mat removably attached to a motor vehicle wherein the mat is storable inside the motor vehicle and when the automobile tailgate guard is in use the mat forms a barrier between user selected portions of the exterior of the motor vehicle and the user.

2. The automobile tailgate guard of claim 1 wherein the mat is removably attached to the motor vehicle by one or more straps utilizing a hook and loop connecting means.

3. The automobile tailgate guard of claim 1 wherein the mat is removably attached to the motor vehicle by one or more straps utilizing a snap connecting means.

4. The automobile tailgate guard of claim 1 wherein the mat is removably attached to the motor vehicle by one or more straps utilizing a button and button hole connecting means.

5. The automobile tailgate guard of claim 1 wherein the mat is removably attached to the motor vehicle by one or more straps utilizing a latch and clip connecting means.

6. An automobile tailgate guard comprising:
a mat removably attached to a motor vehicle wherein the mat is storable inside the motor vehicle and when the automobile tailgate guard is in use the mat forms a barrier between user selected portions of the exterior of the motor vehicle and the user;
the mat further comprising a series of one or more frames which provide predetermined folding locations on the mat such that the mat is in a folded condition when stored in the motor vehicle.

7. The automobile tailgate guard of claim 6 wherein the mat is removably attached to the motor vehicle by one or more straps utilizing a hook and loop connecting means.

8. The automobile tailgate guard of claim 6 wherein the mat is removably attached to the motor vehicle by one or more straps utilizing a snap connecting means.

9. The automobile tailgate guard of claim 6 wherein the mat is removably attached to the motor vehicle by one or more straps utilizing a button and button hole connecting means.

10. The automobile tailgate guard of claim 6 wherein the mat is removably attached to the motor vehicle by one or more straps utilizing a latch and clip connecting means.

11. An automobile tailgate guard comprising:
a mat removably attached to a motor vehicle wherein the mat is storable inside the motor vehicle and when the automobile tailgate guard is in use the mat forms a barrier between user selected portions of the exterior of the motor vehicle and the user;
the mat further comprising a recoiling roller means which when activated by a user permits the mat to remain partially or fully extended from a recoiled rolled position and such that the mat is in a rolled up condition when stored in the motor vehicle.

12. The automobile tailgate guard of claim 11 wherein the mat is removably attached to the motor vehicle by one or more straps utilizing a hook and loop connecting means.

13. The automobile tailgate guard of claim 11 wherein the mat is removably attached to the motor vehicle by one or more straps utilizing a snap connecting means.

14. The automobile tailgate guard of claim 11 wherein the mat is removably attached to the motor vehicle by one or more straps utilizing a button and button hole connecting means.

15. The automobile tailgate guard of claim 11 wherein the mat is removably attached to the motor vehicle by one or more straps utilizing a latch and clip connecting means.
